(19) United States
(12) Patent Application Publication
(10) Pub. No.: US 2025/0068256 A1
(43) Pub. Date: Feb. 27, 2025

(54) KEYBOARD LETTER AREA LAYOUT METHOD

(71) Applicant: Qimin LIU, Wuhan (CN)

(72) Inventor: Qimin LIU, Wuhan (CN)

(21) Appl. No.: 18/940,755

(22) Filed: Nov. 7, 2024

Related U.S. Application Data
(63) Continuation of application No. PCT/CN2023/092125, filed on May 5, 2023.

(30) Foreign Application Priority Data
May 7, 2022 (CN) 202210492235.1

(51) Int. Cl. G06F 3/02

(52) U.S. Cl. CPC G06F 3/0219

(57) ABSTRACT

This invention relates to a keyboard letter zone layout method, specifically designed for physical and on-screen keyboards used for data input on devices such as mobile phones, tablets, and computers. The layout includes 26 letter keys (A, B, C, D . . . E, F, G) and serves as an input method for hardware or electronic device software. The keyboard letter zone is divided into 8 regions based on the rhythm of the alphabet song, with each region corresponding to a segment of the song's rhythm and containing multiple keys.

By utilizing the popular rhythm of the alphabet song, this layout makes it intuitive to remember letter positions, allowing users to locate each letter on the keyboard quickly without needing intensive learning. With a short period of practice, users can achieve proficient touch typing with both hands.

### RELATED APPLICATIONS

The present patent document is a continuation of PCT Application Serial No. PCT/CN2023/092125, filed May 5, 2023, designating the United States and published in English, which is hereby incorporated by reference.

The present patent document claims the benefit of priority to patent application No. 202210492235.1, filed May 7, 2022, and entitled “KEYBOARD LETTER AREA LAYOUT METHOD,” the entire contents of each of which are incorporated herein by reference.

### BACKGROUND

### 1. Technical Field

This invention pertains to the input of information using a keyboard, presenting a method for the layout of keyboard letters.

### 2. Background Information

The QWERTY keyboard is the most commonly used keyboard globally for mobile phones, tablets, and computers. Its name comes from the first six letters on the top row of the letter area. It originated from the Sholes and Glidden Typewriter, with the drawback of an irregular letter arrangement that requires a long familiarization period and has a high learning cost.

U.S. Pat. No. 2,040,248A discloses a keyboard layout designed to balance the workload between the right and left hands, maximizing the load on the middle row and alternating hand sequences to increase input speed. However, its drawback is that it is not suitable for everyday keyboard use and is difficult to memorize.

Patent CN103995603A discloses a keyboard layout designed based on the characteristics of Chinese characters to improve input efficiency and reduce the learning cost of keyboards. Its limitation is that it only enhances Chinese character input efficiency without addressing ease of memorization.

U.S. Pat. Nos. 5,584,588A and 4,615,629 disclose a keyboard layout based on alphabetical order, but its drawback is that it lacks user-friendliness, making it challenging for human memory retention.

### BRIEF SUMMARY

To address the aforementioned issue, this invention presents a method for the layout of the keyboard letter area based on the widely popular alphabet song. The layout of the keyboard letter area designed based on this method can assist users in familiarizing themselves with the keyboard through the melody of music. Without the need for formal study, users can swiftly locate each letter on the keyboard. With a brief period of training, users can achieve touch typing with both hands.

In terms of the keyboard letter area layout, it comprises hardware or software keyboards consisting of 26 letter keys labeled A, B, C, D, E, F, G . . . . The keyboard layout is segmented into multiple zones based on the rhythm of the “Alphabet Song,” with each zone corresponding to a segment of the song's beat. Each zone contains a set number of key positions, with each position accommodating at most one letter, or none at all.

Further, the keyboard letter layout is based on eight-beat patterns from three different “Alphabet Song” variations. The eight beats of the first version are: ABCD, EFG, HIJK, LMNOP, QRS, TUV, WX, YZ; the second version's beats are: ABCD, EFG, HIJK, LMN, OPQ, RST, UVW, XYZ; and the third version's beats are: ABCD, EFG, HIJK, LMN, OPQR, STU, VWX, YZ. These rhythms divide the letter area into eight zones arranged in specific patterns, where each zone has a number of key positions according to the respective “Alphabet Song” version, with each zone containing at least as many positions as letters in the corresponding song segment.

Additionally, in the layout, the first beat corresponds to four key positions, the second to three, the third to four, the fourth to five, the fifth to four, the sixth to three, the seventh to three, and the eighth to three. Within each zone, the keys are arranged alphabetically, with no restrictions on the overall left-right or up-down positioning of letters. Keys (1, 2, 3, 4) are arranged as A, B, C, D; keys (5, 6, 7) as E, F, G; and keys (8, 9, 10, 11) as H, I, J, K.

For different “Alphabet Song” rhythms, the layout includes keys (26, 12, 13, 14, 28) arranged as L, M, N, O, P; keys (15, 16, 17, 18) contain Q, R, S, blank; keys (19, 20, 21) are T, U, V; and keys (22, 23, 24) include W, blank, X, while keys (25, 27) are arranged as Y, Z. Blank spaces within the letter zones can hold any character and are freely placeable, not affecting the character sequence within the zone.

In another variation, the layout uses keys (12, 13, 14, 28) with characters L, M, N, blank; keys (15, 16, 17, 18) contain O, P, Q, blank; keys (19, 20, 21) as R, S, T; and keys (22, 23, 24) as U, V, W. This arrangement divides the letter area into eight regions in a three-row layout with nine key positions in the first row, ten in the second, and nine in the third. Based on the “Alphabet Song” beats, the zones are set up with the first four keys (1, 2, 3, 4) as Zone 1, the next three (5, 6, 7) as Zone 2, and so on, following the song's rhythm.

Compared to existing keyboard layouts, this invention has several advantages, including improved input efficiency and ease of memorizing letter positions. By aligning the letter area with the rhythm of the popular “Alphabet Song,” users can remember letter positions easily. The design enables users to quickly find letters on the keyboard and achieve touch typing with both hands after minimal training.

### BRIEF DESCRIPTION OF THE DRAWINGS

FIG. 1: Schematic diagram of numerical numbering in the keyboard letter zone.

FIG. 2: Schematic diagram of the rhythm for the first alphabet song.

FIG. 3: Schematic diagram of the rhythm for the second alphabet song.

FIG. 4: Schematic diagram of the rhythm for the third alphabet song.

FIG. 5: Schematic diagram showing the three types of keyboard segmentation.

FIG. 6: Schematic diagram of the two types of key arrangements.

FIG. 7: Diagram of the letter arrangement for the first three segments in the universal keyboard layout method.

FIG. 8: Schematic diagram of the keyboard segmented by rows.

FIG. 9: Implementation example of a keyboard layout segmented by rows based on the rhythm of the first alphabet song.

FIG. 10: Implementation example of a keyboard layout segmented by rows based on the rhythm of the second alphabet song.

FIG. 11: Implementation example of a keyboard layout segmented by rows based on the rhythm of the third alphabet song.

FIG. 12: Schematic diagram of the keyboard segmented by columns.

FIG. 13: Implementation example of a keyboard layout segmented by columns based on the rhythm of the second alphabet song.

### DETAILED DESCRIPTION OF THE DRAWINGS AND THE PRESENTLY PREFERRED EMBODIMENTS

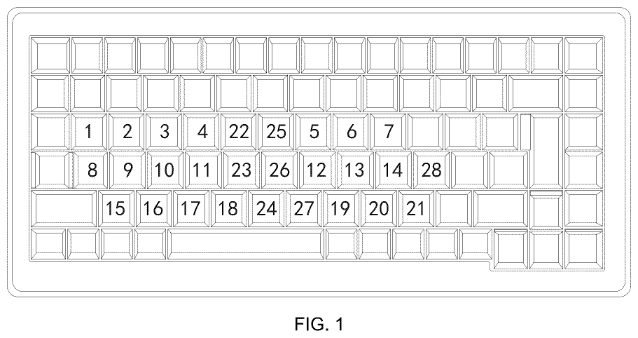

As shown in FIG. 1, the letter zone of the keyboard consists of 28 keys numbered 1-28. Each letter corresponds to one number from 1 to 28, with each number being assigned a maximum of one letter or no letter.

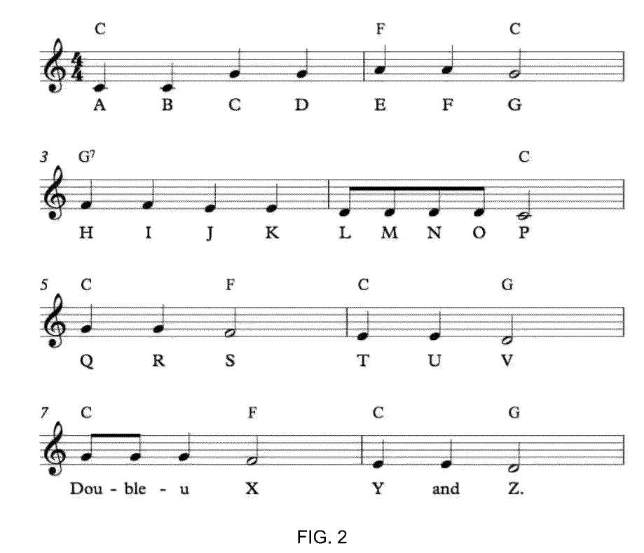

FIGS. 2, 3, and 4 illustrate the rhythmic breakdowns of three versions of the alphabet song;

FIG. 2: First version rhythm: ABCD, EFG, HIJK, LMNOP, QRS, TUV, WX, YZ.

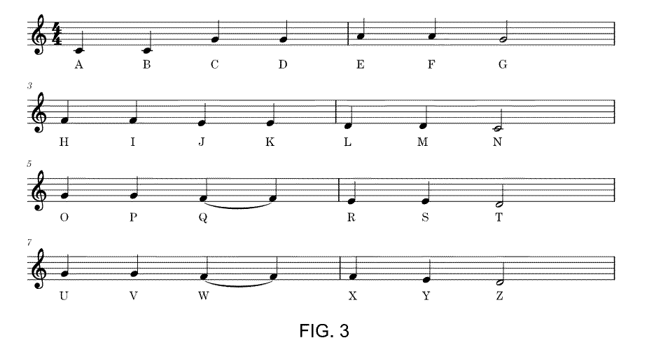

FIG. 3: Second version rhythm: ABCD, EFG, HIJK, LMN, OPQ, RST, UVW, XYZ.

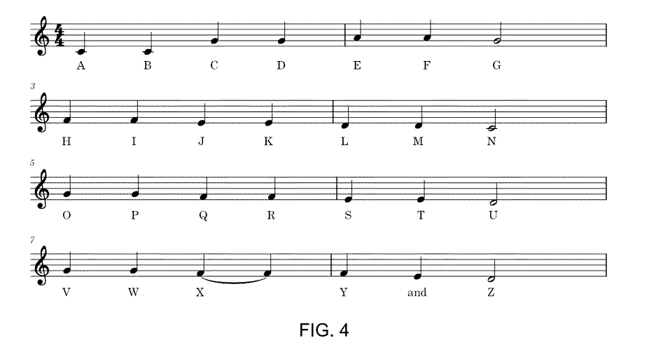

FIG. 4: Third version rhythm: ABCD, EFG, HIJK, LMN, OPQR, STU, VWX, YZ.

The keyboard arrangement applies to input devices on hardware or electronic software. The letter zone layout is segmented by alphabet song rhythms, with each section of the rhythm corresponding to a group of keys that contain at most one letter per key, or may include blank keys.

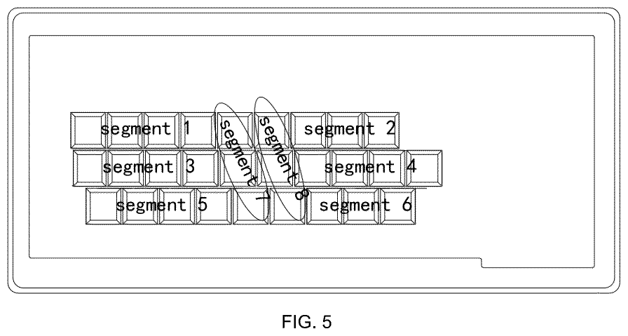

FIG. 5 demonstrates the keyboard segmentation based on the three alphabet song versions. The letter zone is divided into eight segments according to the rhythm of the alphabet song. These segments can be arranged in a typical horizontal or vertical orientation or a combination of both. Each segment contains a number of keys that meet or exceed the number of letters in each rhythm segment.

The number of keys per rhythm segment in FIG. 5 is:
First rhythm segment: 4 keys
Second rhythm segment: 3 keys
Third rhythm segment: 4 keys
Fourth rhythm segment: 5 keys
Fifth rhythm segment: 4 keys
Sixth rhythm segment: 3 keys
Seventh rhythm segment: 3 keys

Eighth rhythm segment: 3 keys

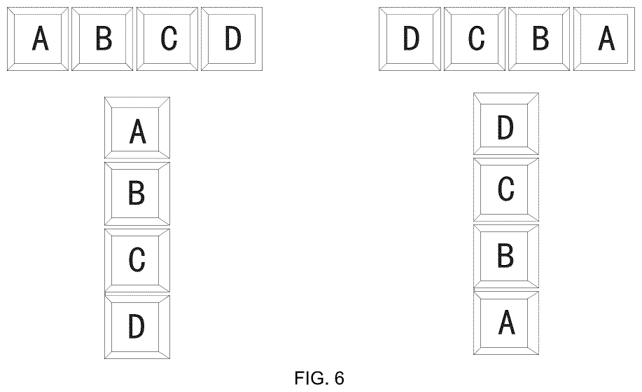

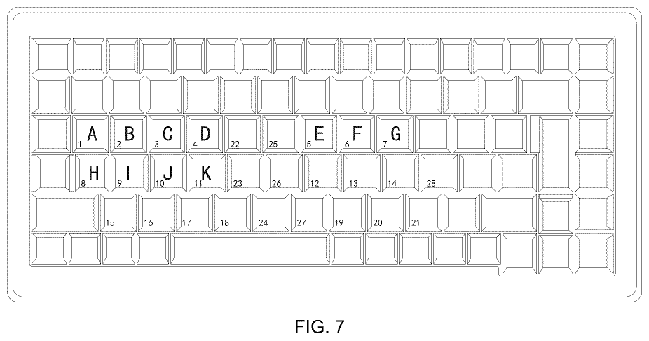

FIG. 6 shows the alphabetical arrangement within each segment, which can be oriented in any direction. The sequence can run left-to-right (e.g., A, B, C, D), right-to-left (D, C, B, A), top-to-bottom, or bottom-to-top. FIG. 7 illustrates the letter arrangement for the first three segments:
Keys 1, 2, 3, 4 contain A, B, C, D
Keys 5, 6, 7 contain E, F, G
Keys 8, 9, 10, 11 contain H, I, J, K

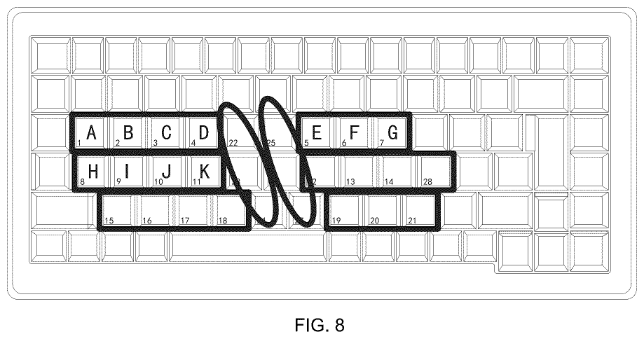

FIG. 8 provides a row-based keyboard segmentation, dividing the letter zone into three rows with eight segments:
Row 1: Segment 1 (keys 1, 2, 3, 4) and Segment 2 (keys 5, 6, 7)
Row 2: Segment 3 (keys 8, 9, 10, 11) and Segment 4 (keys 12, 13, 14, 28)
Row 3: Segment 5 (keys 15, 16, 17, 18) and Segment 6 (keys 19, 20, 21)
Segment 7 includes keys 22, 23, 24 in all rows; Segment 8 includes keys 25, 26, 27 in all rows.

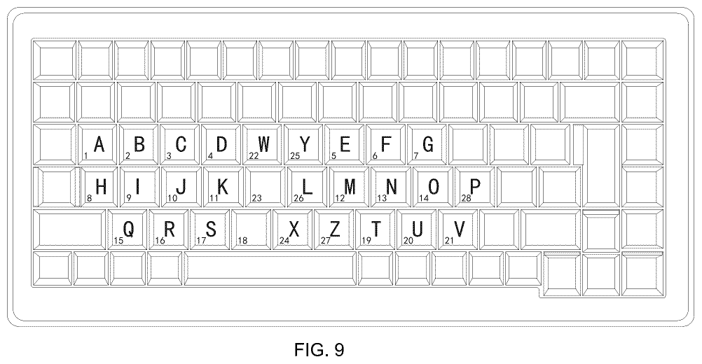

FIGS. 9-11 provide examples of keyboard layouts based on each alphabet song rhythm, arranged in rows:

FIG. 9: Layout based on the first rhythm, with keys 1-4 in Segment 1 (A, B, C, D), keys 5-7 in Segment 2 (E, F, G), and so on.

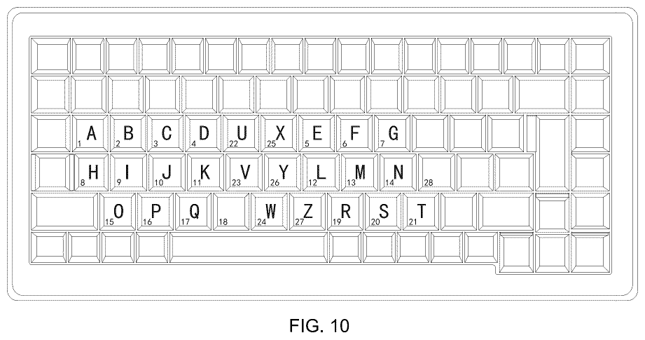

FIG. 10: Layout based on the second rhythm, with each segment arranged similarly and blank spaces that do not disrupt the sequence.

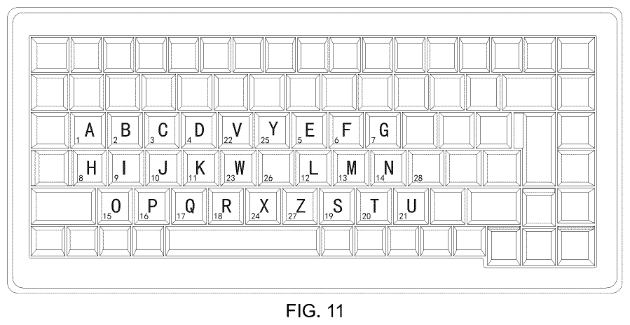

FIG. 11: Layout based on the third rhythm, with an arrangement that places blank spaces in each segment as necessary.

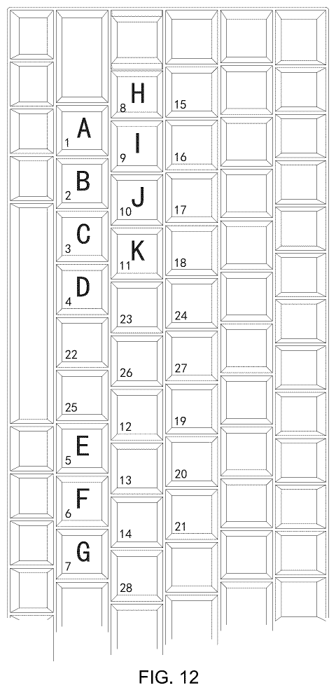

FIG. 12 shows the column-based layout where the letter zone is divided into three columns, with eight segments arranged in columns:
Column 1 contains Segments 1 and 2
Column 2 contains Segments 3 and 4
Column 3 contains Segments 5 and 6
Segments 7 and 8 span all three columns.

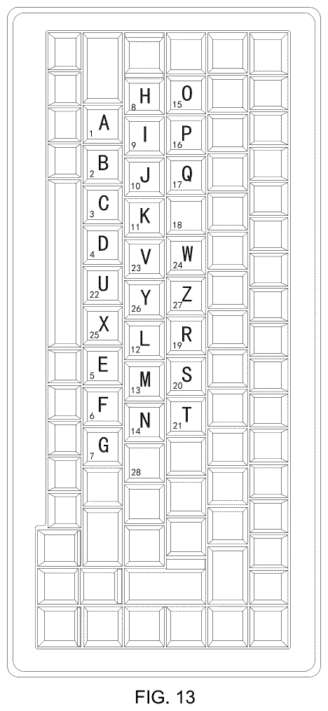

FIG. 13 illustrates an example layout based on one of the rhythmic versions. For instance, Segment 4 (keys 12, 13, 14, 28) contains L, M, N, and blank, Segment 5 (keys 15, 16, 17, 18) contains O, P, Q, blank, and so on.

1. A layout method for the alphabetical area of a keyboard, characterized by setting up the alphabetical area into 8 zones based on the rhythm of the alphabet song; each zone contains several keys, with each key capable of holding at most one letter, or no letter at all; keys without letters may hold any symbol; among the eight zones, six are oriented horizontally while two are oriented vertically, with the two vertical zones being adjacent and separating the six horizontal zones.

2. According to the keyboard alphabetical area layout method described in claim 1, the keyboard letter zone layout is based on three alphabetic songs with eight rhythmic segments each; these are:
Song 1: ABCD, EFG, HIJK, LMNOP, QRS, TUV, WX, YZ;
Song 2: ABCD, EFG, HIJK, LMN, OPQ, RST, UVW, XYZ; and
Song 3: ABCD, EFG, HIJK, LMN, OPQR, STU, VWX, YZ.

3. According to the keyboard alphabetical area layout method described in claim 2, the last two segments of each alphabet song are placed in the vertical zones, while the remaining segments are placed in the horizontal zones; the number of keys within each zone is set according to the number of letters in the corresponding alphabet song segment, with each zone containing at least as many keys as the letters in its segment.

4. According to the keyboard alphabetical area layout described in claim 2, four keys correspond to the first segment of the alphabet song, three keys correspond to the second segment, four keys correspond to the third segment, five keys correspond to the fourth segment, four keys correspond to the fifth segment, three keys correspond to the sixth segment, three keys correspond to the seventh segment, and three keys correspond to the eighth segment.

5. According to the keyboard alphabetical area layout described in claim 3, the keys within each zone are arranged in alphabetical order without restriction on the overall directional orientation (up, down, left, or right) of the letter combinations; the character order for keys (1, 2, 3, 4) is A, B, C, D; for keys (5, 6, 7) is E, F, G; and for keys (8, 9, 10, 11) is H, I, J, K.

6. According to the keyboard alphabetical area layout described in claim 5, based on the layout of different alphabet song rhythms, the character order for keys (26, 12, 13, 14, 28) is L, M, N, O, P; for keys (15, 16, 17, 18) includes Q, R, S, and a blank; for keys (19, 20, 21), the character order is T, U, V; for keys (22, 23, 24) includes W, a blank, and X; and for keys (25, 27), the character order is Y, Z; blank positions in the alphabetical area may hold any character, can be placed anywhere within the zone, and do not affect the sequential order of characters within the zone.

7. According to the keyboard alphabetical area layout described in claim 5, based on the layout of different alphabet song rhythms, the characters for keys (12, 13, 14, 28) include L, M, N, and a blank; for keys (15, 16, 17, 18) include O, P, Q, and a blank; the character order for keys (19, 20, 21) is R, S, T; for keys (22, 23, 24) is U, V, W; and for keys (25, 26, 27) is X, Y, Z; blank positions in the alphabetical area may hold any character, can be placed anywhere within the zone, and do not affect the sequential order of characters within the zone.

8. According to the keyboard alphabetical area layout described in claim 5, based on the layout of different alphabet song rhythms, the characters for keys (12, 13, 14, 28) include L, M, N, and a blank; the character order for keys (15, 16, 17, 18) is O, P, Q, R; for keys (19, 20, 21) is S, T, U; for keys (22, 23, 24) is V, W, X; and for keys (25, 26, 27) includes Y, a blank, and Z; blank positions in the alphabetical area may hold any character, can be placed anywhere within the zone, and do not affect the sequential order of characters within the zone.

9. According to the keyboard alphabetical area layout described in claim 3, the feature lies in dividing the letters area into three rows based on an octet rhythm of letters, with eight regions established; the first row comprises nine key positions, the second row comprises ten key positions, and the third row comprises nine key positions; there is a certain spacing at the beginning of each row, following the conventional keyboard row spacing as a reference, the first four keys of the first row (1, 2, 3, 4) constitute the first region, while the three keys from the seventh to the ninth in the first row (5, 6, 7) form the second region; the first four keys of the second row (8, 9, 10, 11) make up the third region, and the five keys from the sixth to the tenth in the second row (26, 12, 13, 14, 28) constitute the fourth region; the first four keys of the third row (15, 16, 17, 18) form the fifth region, and the three keys from the seventh to the ninth position in the third row (19, 20, 21) make up the sixth region; the fifth keys of the first, second, and third rows, totaling three keys (22, 23, 24), constitute the seventh region; the sixth keys of the first, second, and third rows, totaling three keys (25, 26, 27), form the eighth region; in the first region of the letters area of the keyboard, the characters arranged from left to right on the first four keys (1, 2, 3, 4) are A, B, C, D, while in the second region of the letters area, the characters arranged from left to right on the three keys (5, 6, 7) are E, F, G, and in the third region of the letters area, the characters arranged from left to right on the four keys (8, 9, 10, 11) are H, I, J, K.

10. The keyboard letter zone layout according to claim 9, based on a rhythm layout where:
Segment 4 (12, 13, 14, 28) contains M, N, O, P;
Segment 5 (15, 16, 17, 18) contains Q, R, S, blank;
Segment 6 (19, 20, 21) contains T, U, V;
Segment 7 (22, 23, 24) contains W, blank, X; and
Segment 8 (25, 26, 27) contains Y, L, Z.

11. The keyboard letter zone layout according to claim 9, with an arrangement where:
Segment 4 (12, 13, 14, 28) contains L, M, N, blank;
Segment 5 (15, 16, 17, 18) contains O, P, Q, blank;
Segment 6 (19, 20, 21) contains R, S, T;
Segment 7 (22, 23, 24) contains U, V, W; and
Segment 8 (25, 26, 27) contains X, Y, Z.

12. According to the keyboard alphabetical area layout method described in claim 9,
Segment 4 (12, 13, 14, 28) contains L, M, N, blank;
Segment 5 (15, 16, 17, 18) contains O, P, Q, R;
Segment 6 (19, 20, 21) contains S, T, U;
Segment 7 (22, 23, 24) contains V, W, X; and
Segment 8 (25, 26, 27) contains Y, blank, Z.
